(19) United States
(12) Patent Application Publication
(10) Pub. No.: US 2016/0374461 A1
(43) Pub. Date: Dec. 29, 2016

(54) BRUSH

(71) Applicant: Te-Kung LEE, Taipei City (TW)

(72) Inventor: Te-Kung LEE, Taipei City (TW)

(21) Appl. No.: 14/749,858

(22) Filed: Jun. 25, 2015

(51) Int. Cl. A46B 5/02; B25G 1/10; B25G 1/00

(52) U.S. Cl. CPC A46B 5/026; B25G 1/00; B25G 1/102

(57) ABSTRACT

A brush includes a brush body and a liquid-resisting tray. The brush body includes a brush head part, a connecting part and a handle part. The connecting part has a first end and a second end which are opposite to each other. The first end and the second end are connected to the brush head part and the handle part, respectively. The liquid-resisting tray is installed on the connecting part. A length of the brush head part is a. A length of the handle part is b. A length parameter associated with the length of brush head part and the length of handle part is K, wherein K=(a+b)/a, and 2.363≦K≦2.889.

### TECHNICAL FIELD

The disclosure relates to a brush, more particularly to a brush having a liquid-resisting tray.

### BACKGROUND

Good teeth brushing habits are beneficial for people to maintain oral hygiene and avoid tooth decay. Therefore, in various occasions, the health department of government and dentists constantly remind people to develop a habit of brushing teeth after each meal.

However, when a user is using a conventional tooth brush to brush his/her teeth, the foam in his/her mouth often flows to his/her forearm through the tooth brush and his/her fingers. If the user wears a long-sleeved shirt, the foam will wet and leave stains on the sleeve, which are difficult to be removed. Therefore, the user wearing the long-sleeve shirt has to roll up the sleeve before brushing his/her teeth, or the user has to always pay attention to the foam.

### SUMMARY

According to one embodiment of the present disclosure, a brush includes a brush body and a liquid-resisting tray. The brush body includes a brush head part, a connecting part and a handle part. The connecting part has a first end and a second end which are opposite to each other. The first end is connected to the brush head part. The second end is connected to the handle part. The liquid-resisting tray is installed on the connecting part. A length of the brush head part is a. A length of the handle part is b. A length parameter associated with the length of brush head part and the length of handle part is K. A distance between the liquid-resisting tray and the first end of the connecting part is a tolerance parameter D1. A distance between the liquid-resisting tray and the second end of the connecting part is a tolerance parameter D2. A total length of the brush body is a first length L1. A length between a side of the brush head part away from the connecting part and the liquid-resisting tray is a second length L2. The following conditions are satisfied:

K=(a+b)/a;

2.363≦K≦2.889; and

L1=(L2−D1)×K+(D1+D2).

According to another embodiment of the present disclosure, a brush includes a brush body and a liquid-resisting tray. The brush body includes a brush head part, a connecting part and a handle part. The connecting part has a first end and a second end which are opposite to each other. The first end is connected to the brush head part. The second end is connected to the handle part. The liquid-resisting tray is installed on the connecting part. The liquid-resisting tray includes a fixing section, a first liquid-resisting section and a second liquid-resisting section. The fixing section is installed on the connecting part. The first liquid-resisting section is connected to the fixing section and surrounding the connecting part. The second liquid-resisting section is connected to and surrounding the first liquid-resisting section. The second liquid-resisting section is inclined to the first liquid-resisting section.

### BRIEF DESCRIPTION OF THE DRAWINGS

The present disclosure will become more fully understood from the detailed description given hereinbelow and the accompanying drawings which are given by way of illustration only and thus are not limitative of the present invention and wherein:

FIG. 1 is a schematic perspective view of a brush according to a first embodiment of the disclosure;

FIG. 2 is a cross-sectional view of the brush according to the first embodiment of the disclosure;

FIG. 3 is a front view of the brush according to the first embodiment of the disclosure;

FIG. 4 is a side view of the brush held by a user according to the first embodiment of the disclosure;

FIG. 5 is a schematic perspective view of a brush according to a second embodiment of the disclosure;

FIG. 6 is a cross-sectional view of a brush according to the second embodiment of the disclosure;

FIG. 7 is a schematic exploded view of a brush according to a third embodiment of the disclosure;

FIG. 8 is a top view of a liquid-resisting tray of the brush according to the third embodiment of the disclosure;

FIG. 9 is a cross-sectional view of the liquid-resisting tray of the brush according to the third embodiment of the disclosure; and

FIG. 10 is a bottom view of the liquid-resisting tray of the brush according to the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

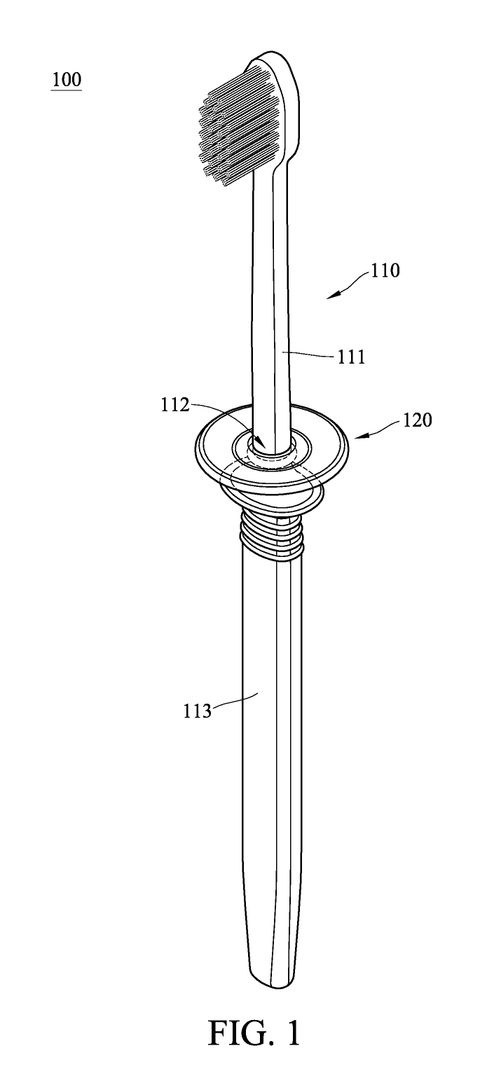

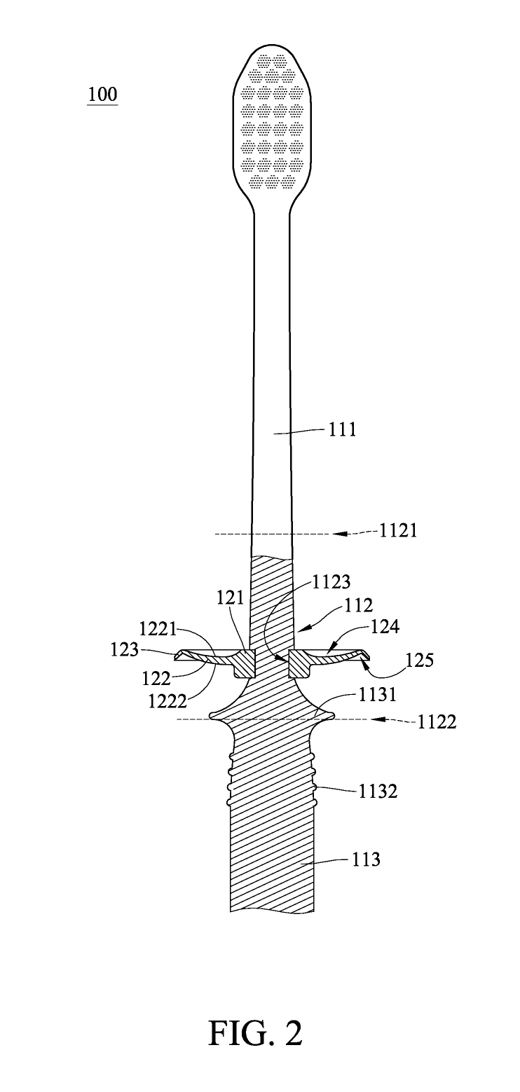

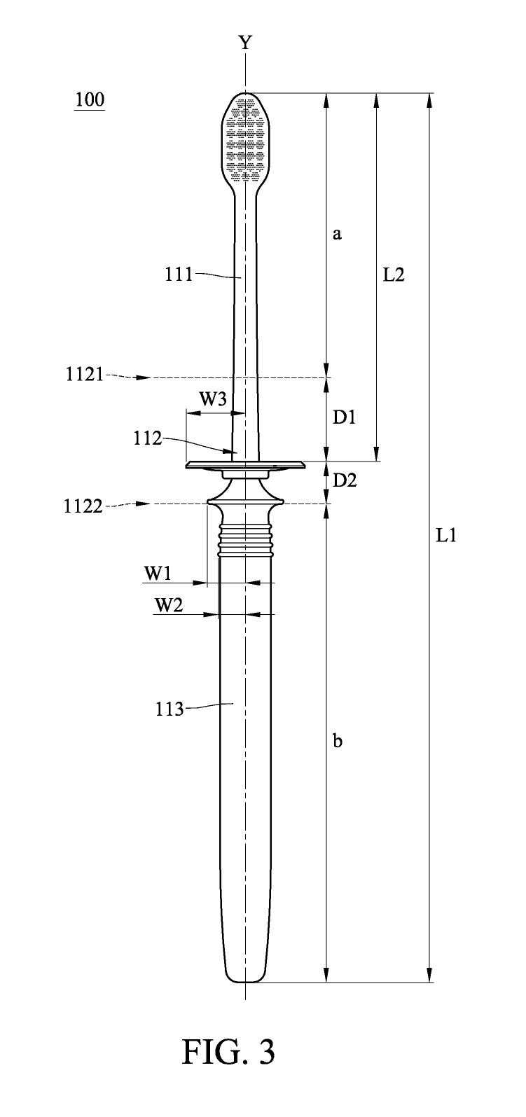

The following describes the brush 100 of a first embodiment of the present disclosure. Please refer to FIG. 1 to FIG. 3. FIG. 1 is a schematic perspective view of a brush according to a first embodiment of the disclosure. FIG. 2 is a cross-sectional view of the brush according to the first embodiment of the disclosure. FIG. 3 is a front view of the brush according to the first embodiment of the disclosure. In the first embodiment of the present disclosure, the brush 100 includes a brush body 110 and a liquid-resisting tray 120. The brush body 110 includes a brush head part 111, a connecting part 112 and a handle part 113. The brush head part 111 and the handle part 113 are connected via the connecting part 112.

The connecting part 112 has a first end 1121, a second end 1122 and a fixing portion 1123. The first end 1121 and the second end 1122 are opposite to each other. The first end 1121 and the second end 1122 are connected to the brush head part 111 and the handle part 113, respectively. The fixing portion 1123 is located between the first end 1121 and the second end 1122. The fixing portion 1123, for example, is a recess formed on a surface of the connecting part 112.

The connecting part 112 further includes a stopper 1131. The stopper 1131 is located at an end of the connecting part 112 which is away from the brush head part 111. For example, the stopper 1131 is located at the second end 1122 of the connecting part 112. The stopper 1131 protrudes out from the surface of the connecting part 112 to provide a tactile feedback for a user in response to the user holding and touching the handle part 113. The tactile feedback provided by the stopper 1131 reminds the user that a location of the stopper 1131 is one boundary of a holding area for the user to grip the brush 100. The reason why the holding area is limited will be explained later. Moreover, a distance between an edge of the stopper 1131 to a central axis Y of the brush body 110 is a first width W1. In the first embodiment of the disclosure, the stopper 1131 is one protrusion which protrudes out from the surface of the connecting part 112 and surrounds the surface of the connecting part 112. However, the disclosure is not limited to the shape or number of the stopper. In other embodiments of the disclosure, the stopper can be a recess extending around the periphery of the connecting part. The stopper can also be a plurality of recesses or a plurality of protrusions that is located on the periphery of the connecting part.

The handle part 113 has an anti-slip portion 1132. The anti-slip portion 1132 is located at an end of the handle part 113 adjacent to the brush head part 111. The anti-slip portion 1132, for example, has four rings which protrude out from a surface of the handle part 113. A distance between an edge of the anti-slip portion 1132 and the central axis Y of the brush body 110 is a second width W2, and the second width W2 is smaller than the first width W1. The anti-slip portion 1132 is for increasing a friction between the fingers of the user and the surface of the handle part 113 so that the user can steadily hold the handle part 113. In the first embodiment of the disclosure, the anti-slip portion 1132 is four rings which protrude out from the surface of the handle part 113. However, the disclosure is not limited to the shape or number of structure of the anti-slip portion. In other embodiments of the disclosure, the anti-slip portion can have a recess extending around the periphery of the surface of the handle part. The number of rings or recesses of the anti-slip portion can also be less than four or more than four.

The liquid-resisting tray 120 is installed on the connecting part 112 of the brush body 110. A distance between the liquid-resisting tray 120 and the brush head part 111 is shorter than a distance between the stopper 1131 and the brush head part 111. Therefore, when the user is brushing teeth, the liquid-resisting tray 120 can resist the foam or the water in his/her mouth flowing along the brush body 110 from the brush head part 111 to the handle part 113, and a situation that the foam or the water wets his/her hand holding the handle part 113 is avoid. In addition, the liquid-resisting tray 120 includes a fixing section 121, a first liquid-resisting section 122 and a second liquid-resisting section 123. The fixing section 121 and the fixing portion 1123 of the connecting part 112 are matched in shape and size so that the fixing section 121 is able to be fixed in the fixing portion 1123. Therefore, the liquid-resisting tray 120 is able to be installed on the connecting part 112. In the first embodiment of the disclosure, the fixing portion 1123 is an annular groove that extends around the periphery of the surface of the connecting part 112, and the fixing section 121 is securely fixed in the fixing portion 1123. However, the disclosure is not limited to the way how the liquid-resisting tray is installed on the connecting part. In other embodiments of the disclosure, the fixing section of the liquid-resisting tray can be tightly fitted to the connecting part of the brush body so that the fixing section is fixed to the connecting part without the fixing portion. Alternatively, the fixing section of the liquid-resisting tray can be detachably disposed in the fixing portion.

The first liquid-resisting section 122 is connected to the fixing section 121 and surrounding the connecting part 112. The first liquid-resisting section 122 has a front side 1221 and a rear side 1222 which are opposite to each other. The front side 1221 faces the brush head part 111. The rear side 1222 faces the handle part 113. A liquid-guiding groove 124 extends around the fixing section 121 is located at the front side 1221 of the first liquid-resisting section 122. When the user is brushing teeth, the foam or the water flows along the brush head part 111, the connecting part 112, the fixing section 121 of the liquid-resisting tray 120, the front side 1221 of the first liquid-resisting section 122 in sequence and arrives in the liquid-guiding groove 124. Then, the liquid-guiding groove 124 guides and merges the foam or the water to an area of the first liquid-resisting section 122 which is closer to the ground than other areas of the first liquid-resisting section 122 along the liquid-guiding groove 124. In other words, the foam or the water is guided to a relatively lower side of the first liquid-resisting section 122.

The second liquid-resisting section 123 is connected to and surrounding the first liquid-resisting section 122. Moreover, the second liquid-resisting section 123 is inclined to the first liquid-resisting section 122. Since the second liquid-resisting section 123 is connected and inclined to the first liquid-resisting section 122, the second liquid-resisting section 123 and the first liquid-resisting section 122 forms a liquid-resisting groove 125 extends around the fixing section 121 together. Specifically, the liquid-resisting groove 125 is formed by the rear side 1222 of the first liquid-resisting section 122 and a side of the second liquid-resisting section 123 away from the brush head part 111. The liquid-resisting groove 125 can resist the foam or the water flowing from the second liquid-resisting section 123 to the rear side 1222 of the first liquid-resisting section 122. A distance between an edge of the second liquid-resisting section 123 and the central axis Y of the brush body 110 is a third width W3, and the third width W3 is greater than the first width W1.

In the first embodiment of the disclosure, the thickness of the first liquid-resisting section 122 and the second liquid-resisting section 123 of the liquid-resisting tray 120 are 6 millimeters (mm). The third width W3, which is the distance between the edge of the second liquid-resisting section 123 and the central axis Y of the brush body 110, is between 12.5 mm and 16.5 mm. However, the disclosure is not limited to the thickness of the liquid-resisting tray 120 or the distance between the edge of the second liquid-resisting section 123 and the central axis Y of the brush body 110. In other embodiments of the disclosure, the thickness of the first liquid-resisting section and the second liquid-resisting section of the liquid-resisting tray can be larger or smaller than 6 mm. The third width W3 can be between 10.5 mm and 18.5 mm.

Moreover, in the first embodiment of the disclosure, the liquid-resisting tray 120 is made of silicone. However, the disclosure is not limited to the material of the liquid-resisting tray. In other embodiments of the disclosure, the liquid-resisting tray can be made of other kinds of elastic polymer.

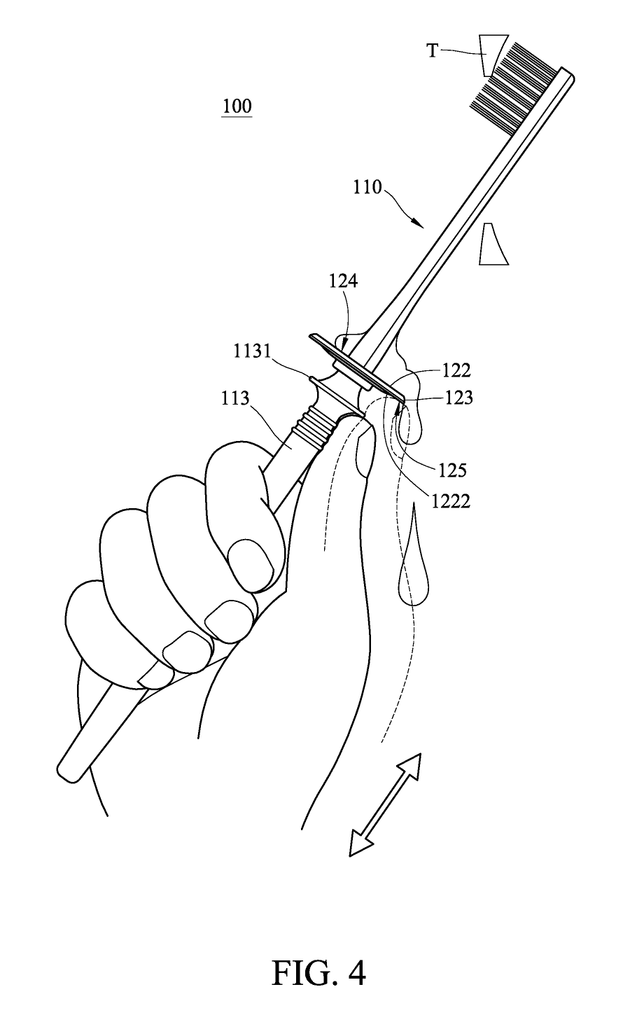

The following describes an operation of the brush 100 of the first embodiment of the present disclosure. Please refer to FIG. 4, which is a side view of the brush held by the user according to the first embodiment of the disclosure.

The brush 100 is stood substantially straight relative to the ground as shown in FIG. 4 when the user is brushing his/her upper incisor teeth T, or the brush 100 is lying horizontally relative to the ground when the user is brushing an occlusal surface or side surface of his/her teeth. When the brush shows the orientations described above, the foam or the water, which is guided and merged by the liquid-guiding groove 124, is driven to flow toward the ground along the second liquid-resisting section 123 of the liquid-resisting tray 120 by gravity. When the foam or the water arrives at the edge of the second liquid-resisting section 123, the foam or the water is joined together at the edge of the second liquid-resisting section 123 because an angle between two side surfaces of the second liquid-resisting section 123 which are opposite to each other is smaller than 90 degrees. Moreover, an angle between the direction of gravity and an elongation direction of the side of the second liquid-resisting section 123 served as a groove wall of the liquid-resisting groove 125 is smaller than 90 degrees so that the foam or the water cannot resist the gravity flowing across the groove wall of the liquid-resisting groove 125 and then flows toward the rear side 1222 of the first liquid-resisting section 122. Furthermore, the third width W3, which is the distance between the edge of the second liquid-resisting section 123 and the central axis Y of the brush body 110, is greater than the first width W1 which is the distance between the edge of the stopper 1131 and the central axis Y of the brush body 110. Therefore, the foam or the water drops from the edge of the second liquid-resisting section 123 to the ground by gravity rather than to the stopper 1131 or the handle part 113 of the brush body 110 along the rear side 1222 of the first liquid-resisting section 122. As the result, when the user is using the brush 100 to brush teeth, the liquid-resisting tray 120 can resist the foam or the water flowing to the handle part 113 along the brush head part 111 and the connecting part 112 of the brush body 110 so that the fingers holding the handle part 113, a wrist and the forearm of the user can stay dry and keep away from the water or the foam.

In addition, to balance the liquid-resisting effect of the liquid-resisting tray 120, holding comfort of the brush 100 and the smooth using of the brush 100, a length of the brush head part 111 and relationships between the brush body 110 and the liquid-resisting tray 120 are deliberately designed. Please refer to FIG. 3, the following descriptions are about lengths of each part of the brush body 110 and the location of the liquid-resisting tray 120 at the connecting part 112 which satisfied a condition L1=(L2−D1)×K+(D1+D2).

First, a total length of the brush body 110 is first length L1, a length of the brush head part 111 is a, and a length of the handle part 113 is b. A second length L2 is a distance between a side of the brush head part 111 away from the handle part 113 and a connecting portion between the first liquid-resisting section 122 and the second liquid-resisting section 123 of the liquid-resisting tray 120 facing the brush head part 111. A length parameter associated with the length of brush head part and the length of handle part is K. The following conditions are satisfied: K=(a+b)/a, 2.363≦K≦2.889 and L1=(L2-D1)×K+(D1+D2). When the above conditions are satisfied, the liquid-resisting tray 120 located on the connecting part 112 of brush body 110 has better liquid-resisting effect than being located at other positions of the brush body 110.

A distance between the connecting portion between the first liquid-resisting section 122 and the second liquid-resisting section 123 facing the brush head part 111 and the first end 1121 of the connecting part 112 is a tolerance parameter D1, and L2=a+D1. The tolerance parameter D1 is a distance for tolerance between the brush head part 111 and the liquid-resisting tray 120 to avoid uncomfortable feeling generated by a contact between the liquid-resisting tray 120 and lips of the user. Considering differences of orals of individuals with different genders, ethnicities and heights, D1/L2 can be between 0.1967 and 0.2878, which means the tolerance parameter D1 is between 13.7 mm and 29.3 mm. Hence, the brush 100 is user-friendly to all kinds of people.

A distance between the connecting portion of the first liquid-resisting section 122 and the second liquid-resisting section 123 facing the brush head part 111 and the second end 1122 of the connecting part 112 is a tolerance parameter D2, and L1−L2=D2+b. The tolerance parameter D2 is a distance of tolerance between the handle part 113 and the liquid-resisting tray 120 to avoid fingers of the user contacting the liquid-resisting tray 120. Hence, the foam or the water may not flow to the forearm along the finger from the liquid-resisting tray 120. Considering differences of finger lengths and palm widths between each individuals, D2/L1 is between 0.0318 and 0.0412, which means the tolerance parameter D2 is between 5.4 mm and 9.1 mm. Hence, the brush 100 is user-friendly to all kinds of people.

Moreover, in terms of the design of the brush 100, the length parameter K, the tolerance parameter D1, the tolerance parameter D2 and the first length L1 are determined in the ranges described above. Then the second length L2 is determined according to the relation L1=(L2−D1)×K+(D1+D2). In another way, the length parameter K, the tolerance parameter D1, the tolerance parameter D2 and the second length L2 are determined in the ranges described above. That is, the first length L1 is determined according to the relation L1=(L2−D1)×K+(D1+D2).

In one example, when the length parameter K=2.889, the tolerance parameter D1=20 mm, the tolerance parameter D2=7 mm, and the first length L1=220 mm, the second length L2 can be calculated to be 86.6 mm and L1−L2 can be 133.2 mm according to the relation L1=(L2−D1)×K+(D1+D2). Then it can be calculated that the length b of the handle part 113 is 126.2 mm according to the relation b=L1−L2−D2 which is derived from L1=(L2−D1)×K+(D1+D2). Then it can be calculated that the length a of the brush head part 111 is 66.8 mm according to the relation a=L2−D1 which is derived from L1=(L2−D1)×K+(D1+D2). In another example, the length parameter K=2.363, the tolerance parameter D1=20 mm, the tolerance parameter D2=7 mm, and the first length L1=220 mm. Then it can be calculated that the second length L2 is 101.7 mm, L1−L2 is 118.3 mm, the length b of the handle part 113 is 111.3 mm and the length a of the brush head part 111 is 81.7 mm according to the relation L1=(L2−D1)×K+(D1+D2).

In another example, when the length parameter K=2.889, the tolerance parameter D1=20 mm, the tolerance parameter D2=7 mm, and the first length L1=170 mm, it can be calculated that the second length L2 is 69.5 mm, L1−L2 is 100.5 mm, the length b of the handle part 113 is 93.5 mm and the length a of the brush head part 111 is 49.5 mm according to the relation L1=(L2-D1)×K+(D1+D2). In other example, when the length parameter K=2.363, the tolerance parameter D1=20 mm, the tolerance parameter D2=7 mm, and the first length L1=170 mm, it can be calculated that the second length L2 is 80.5 mm, L1−L2 is 89.5 mm, the length b of the handle part 113 is 82.5 mm and the length a of the brush head part 111 is 60.5 mm according to L1=(L2−D1)×K+(D1+D2).

According to above descriptions about designing the brush 100, the second length L2 of the brush 100 has a range between 101.7 mm and 69.5 mm, and the second length L2 falls within the range which fulfills a requirement that adults can smoothly brush his/her teeth with the second length L2 of the brush longer than 75 mm, and children can smoothly brush his/her teeth with the second length L2 of the brush longer than 65 mm. A reason of the requirement is that a diagonal distance between a side of a mouth of adults and a rear surface of a molar located at a rear end of another side of the mouth of adults is between 55 mm and 75 mm, and a diagonal distance of children is between 45 mm and 65 mm. Therefore, a minimum average length of the brush head part 111 of the brush body 110 entering the mouth and cleaning the molar located at the rear end of the mouth is 45 mm for children and 55 mm for adults.

Because the brush head part 111 slightly reciprocates in the mouth to brush the teeth, and the difference of the oral size between users with different genders, ethnicities and heights, a tolerance parameter D1 is added into the minimum average length of the brush head part 111 entering the mouth. As a result, the minimum length of the second length L2, i.e., a+D1, which is the distance between the side of the brush head part 111 away from the handle part 113 and the connecting portion between the first liquid-resisting section 122 and the second liquid-resisting section 123 of the liquid-resisting tray 120 facing the brush head part 111, is 65 mm for children and 75 mm for adults.

Moreover, according to above descriptions about designing the brush 100, the length of the handle part 113, which is represented by b, has a range between 82.5 mm and 126.2 mm, and the length of the handle part 113 falls in the above-mentioned range fulfills a requirement that adults can comfortably hold the handle part 113 with the length b of the handle part 113 longer than 90 mm, and children can comfortably hold the handle part 113 with the length b of the handle part 113 longer than 80 mm. A reason of the requirement is that a width of an area of the handle part 113 covered by fingers and palm is between 90 mm and 110 mm when the handle part 113 is held by adults, and a width thereof is between 80 mm and 100 mm when the handle part 113 is held by children. Therefore, a minimum average length of the handle part 113 of the brush body 110 to be comfortably held is 80 mm for children and 90 mm for adults.

When the user brushes the teeth and fingers of the user exceeds the stopper 1131 but does not contact the liquid-resisting tray 120, a path of the foam or the water may be formed on the fingers or the back of hand so that the foam or the water may flow to his/her forearm along the fingers or the back of hand. When the user brushes the teeth and fingers of the user contacts the rear side 1222 of the first liquid-resisting section 122 or the second liquid-resisting section 123 of the liquid-resisting tray 120, the liquid-resisting tray 120 cannot resist the flow of liquid so that the foam or the water may flow from the liquid-resisting tray 120 to his/her forearm along his/her finger or back of hand. Therefore, the stopper 11131, which protrudes out from the surface of the connecting part 112 and which keeps a distance from the rear side 1222, can remind the user to keep his/her finger in the holding area to grip the brush 100. Accordingly, the fingers can keep a distance from the liquid-resisting tray 120. When the length difference of the finger and the width difference of the palm of the users with different genders, ethnicities and heights are considered, a tolerance parameter D2 is added. In detail, the tolerance parameter D2 is a distance between the stopper 1131 and the connecting portion between the first liquid-resisting section 122 and the second liquid-resisting section 123 of the liquid-resisting tray 120 facing the brush head part 111. As a result, the minimum distance between the side of the handle part 113 away from the brush head part 111 and the connecting portion of the liquid-resisting tray 120 facing the brush head part 111, i.e., L1−L2, is 87 mm in the brush for children and 97 mm in the brush for adults.

The following describes about relations between the locations of the liquid-resisting tray and each part of the brush body in brush with different first length L1. Please refer to Table 1, which is a list of the first length L1, a range of the second length L2 and a range of the length of handle part b when the length parameter K is between 2.889 and 2.363. The tolerance parameter D1 is 20 mm and the tolerance parameter D2 is 7 mm.

TABLE 1

| | second length L2(mm) | Length of handle part b(mm) |
|---|---|---|
| first length | (L2 when K = 2.889~L2 | (b when K = 2.889~b |
| L1(mm) | when K = 2.363) | when K = 2.363) |
| 220 | 86.8~101.7 | 126.2~111.3 |
| 219 | 86.5~101.3 | 125.5~110.7 |
| 218 | 86.1~100.8 | 124.9~110.2 |
| 217 | 85.8~100.4 | 124.2~109.6 |
| 216 | 85.4~100.0 | 123.6~109.0 |
| 215 | 85.1~99.6 | 122.9~108.4 |
| 214 | 84.7~99.1 | 122.3~107.9 |
| 213 | 84.4~98.7 | 121.6~107.3 |
| 212 | 84.0~98.3 | 121.0~106.7 |
| 211 | 83.7~97.9 | 120.3~106.1 |
| 210 | 83.3~97.4 | 119.7~105.6 |
| 209 | 83.0~97.0 | 119.0~105.0 |
| 208 | 82.7~96.6 | 118.3~104.4 |
| 207 | 82.3~96.2 | 117.7~103.8 |
| 206 | 82.0~95.8 | 117.0~103.2 |
| 205 | 81.6~95.3 | 116.4~102.7 |
| 204 | 81.3~94.9 | 115.7~102.1 |
| 203 | 80.9~94.5 | 115.1~101.5 |
| 202 | 80.6~94.1 | 114.4~100.9 |
| 201 | 80.2~93.6 | 113.8~100.4 |
| 200 | 79.9~93.2 | 113.1~99.8 |
| 199 | 79.5~92.8 | 112.5~99.2 |
| 198 | 79.2~92.4 | 111.8~98.6 |
| 197 | 78.8~91.9 | 111.2~98.1 |
| 196 | 78.5~91.5 | 110.5~97.5 |
| 195 | 78.2~91.1 | 109.8~96.9 |
| 194 | 77.8~90.7 | 109.2~96.3 |
| 193 | 77.5~90.2 | 108.5~95.8 |
| 192 | 77.1~89.9 | 107.9~95.2 |
| 191 | 76.8~89.4 | 107.2~94.6 |
| 190 | 76.4~89.0 | 106.6~94.0 |
| 189 | 76.1~88.6 | 105.9~93.4 |
| 188 | 75.7~88.1 | 105.3~92.9 |
| 187 | 75.4~87.7 | 104.6~92.3 |
| 186 | 75.0~87.3 | 104.0~91.7 |
| 185 | 74.7~86.9 | 103.3~91.1 |
| 184 | 74.3~86.4 | 102.7~90.6 |
| 183 | 74.0~86.0 | 102.0~90.0 |
| 182 | 73.7~85.6 | 101.3~89.4 |
| 181 | 73.3~85.2 | 100.7~88.8 |
| 180 | 73.0~84.7 | 100.0~88.3 |
| 179 | 72.6~84.3 | 99.4~87.7 |
| 178 | 72.3~83.9 | 98.7~87.1 |
| 177 | 71.9~83.5 | 98.1~86.5 |
| 176 | 71.6~83.1 | 97.4~85.9 |
| 175 | 71.2~82.6 | 96.8~85.4 |
| 174 | 70.9~82.2 | 96.1~84.8 |
| 173 | 70.5~81.8 | 95.5~84.2 |
| 172 | 70.2~81.4 | 94.8~83.6 |
| 171 | 69.8~80.9 | 94.2~83.1 |
| 170 | 69.5~80.5 | 93.5~82.5 |

The above-mentioned brushes all satisfy the relation L1=(L2−D1)×K+(D1+D2) when K is 2.889 or 2.363, D1 is 20 mm, D2 is 7 mm and L1 is between 170 mm and 220 mm. When the first length L1 is fixed, the second length L2 and the length of the handle part b are inversely proportional to each other in a range. Accordingly, the brush can avoid the foam or the water wetting the forearm of the user, the liquid-resisting tray keeps a distance from the lip of the user to avoid uncomfortable feeling for the user when the liquid-resisting tray contacts the lip, and the user can comfortably and steadily hold the handle part. In addition, when the first length L1 of the brush is 220 mm, the distance L2 between the connecting portion between the first liquid-resisting section and the second liquid-resisting section of the liquid-resisting tray facing the brush head part and the side of the brush head part away from the connecting part is between 86.8 mm and 101.7 mm, and the distance b+D2 or L1−L2 between the connecting portion thereof and the side of the handle part away from the connecting part is between 118.3 mm and 133.2 mm. Furthermore, when the first length L1 of the brush is 170 mm, the distance L2 between the connecting portion thereof and the side of the brush head part away from the connecting part is between 69.5 mm and 80.5 mm, and the distance b+D2 or L1−L2 between the connecting portion thereof and the side of the handle part away from the connecting part is between 89.5 mm and 100.5 mm.

Adult users can choose a brush from the brushes abovementioned having the second length L2 longer than 75 mm and the length of the handle part b longer than 90 mm according to their oral depths, finger lengths and palm widths. Children users can also choose a brush from the brushes abovementioned having the second length L2 longer than 65 mm and the length of the handle part b longer than 80 mm according to their oral depths, finger lengths and palm widths. As a result, when using the brush satisfying the condition that L1=(L2−D1)×K+(D1+D2) and K is between 2.889 and 2.363, the user can effectively avoid the foam or the water wetting the forearm. Also, the lip of user may not contact the liquid-resisting tray by keeping a distance between the lips and the liquid-resisting tray. Furthermore, the user is able to comfortably and steadily hold the handle part.

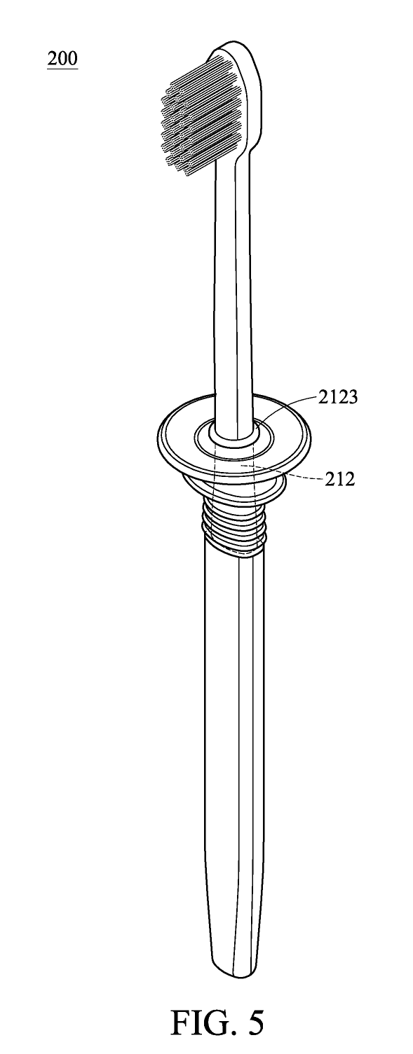

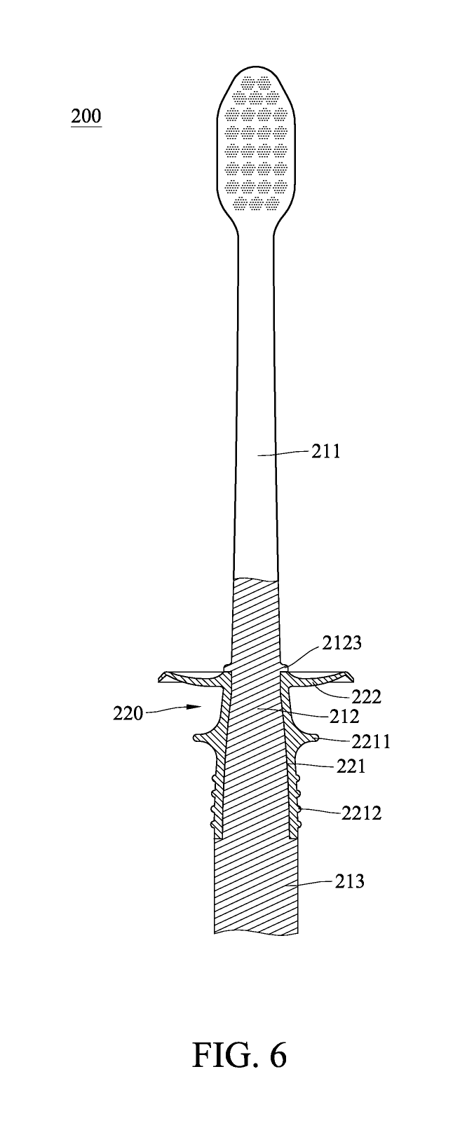

The following describes a brush 200 of a second embodiment of the present disclosure. Please refer to FIG. 5 and FIG. 6, FIG. 5 is a schematic perspective view of a brush according to a second embodiment of the disclosure. FIG. 6 is a cross-sectional view of a brush according to the second embodiment of the disclosure. The second embodiment of the present disclosure in FIG. 5 and FIG. 6 is similar to the first embodiment of the present disclosure in FIG. 1 to FIG. 4. Therefore, the following descriptions focus on the difference between the brush 100 of the first embodiment and the brush 200 of the second embodiment. The explanations of the operations about the same structure of the first embodiment and the second embodiment of the present disclosure are not repeated herein.

In the brush 200 of the second embodiment of the present disclosure, a fixing section 221 of a liquid-resisting tray 220 has two sides which are opposite to each other. A fixing portion 2123 of a connecting part 212 and a side of a handle part 213 facing a brush head part 211 contact the two sides of the fixing section 221, respectively, to fix the liquid-resisting tray 220. The fixing section 221 further has a stopper 2211 and an anti-slip portion 2212. The stopper 2211 and the anti-slip portion 2212 protrude out from a surface of the fixing section 221. A distance between the anti-slip portion 2212 and the brush head part 211 is greater than a distance between a first liquid-resisting section 222 and the brush head part 211. The stopper 2211 is located between the anti-slip portion 2212 and the first liquid-resisting section 222. In the second embodiment of the disclosure, the liquid-resisting tray 220 is fixed to the connecting part 212. However, the disclosure is not limited to the way how the liquid-resisting tray 220 is installed on the connecting part 212. In other embodiments of the disclosure, the liquid-resisting tray is detachably fixed to the connecting part.

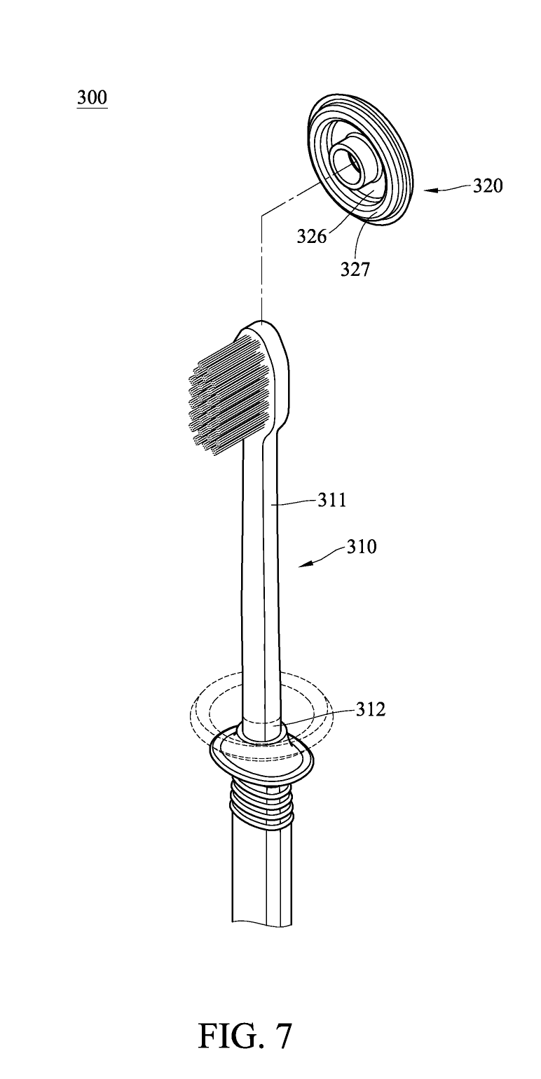

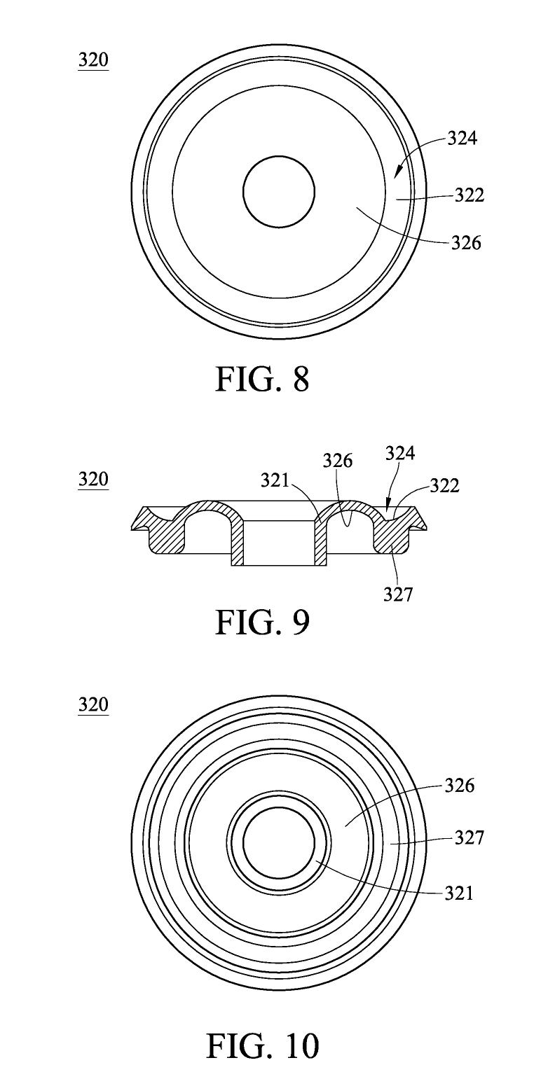

The following describes a brush 300 of a third embodiment of the present disclosure. Please refer to FIG. 7 to FIG. 10. FIG. 7 is a schematic perspective view of a brush according to a third embodiment of the disclosure. FIG. 8 is a top view of a liquid-resisting tray of the brush according to the third embodiment of the disclosure. FIG. 9 is a cross-sectional view of the liquid-resisting tray of the brush according to the third embodiment of the disclosure. FIG. 10 is a bottom view of the liquid-resisting tray of the brush according to the third embodiment of the disclosure. The third embodiment of the present disclosure in FIG. 7 to FIG. 10 is similar to the first embodiment of the present disclosure in FIG. 1 to FIG. 4. Therefore, the following descriptions focus on the difference between the brush 100 of the first embodiment and the brush 300 of the third embodiment. The explanations of the operations about the same structure of the first embodiment and the third embodiment of the present disclosure are not repeated herein.

In the brush 300 of the third embodiment of the present disclosure, a liquid-resisting tray 320 is detachably fixed on a connecting part 312 of a brush body 310. The liquid-resisting tray 320 further includes a curved section 326 and a reinforcing rib 327. The curved section 326 is connecting a fixing section 321 and a first liquid-resisting section 322 so that a distance between the fixing section 321 and the first liquid-resisting section 322 is adjustable to fit connecting parts of brush bodies with different outer diameters. For example, the fixing section 321 and the first liquid-resisting section 322 can be arranged to be closer to or farther away from each other to fit the connecting parts with different outer diameters. Moreover, the reinforcing rib 327 is connected to a side of the first liquid-resisting section 322 away from a brush head part 311, and the reinforcing rib 327 surrounds the fixing section 321. A connecting portion between the first liquid-resisting section 322 and the reinforcing rib 327 has high thickness. Therefore, the connecting portion between the first liquid-resisting section 322 has higher coefficient of elasticity so that an elastic force generated by a deformation of the fixing section 321 is difficult to deform the first liquid-resisting section 322. As a result, a liquid-guiding groove 324 located on the first liquid-resisting section 322 can still guide the liquid to flow to a desired direction when the fixing section is deformed.

According to the brush disclosed in the embodiments of the disclosure, the liquid-resisting tray installed at the connecting part resists the foam or the water flowing toward the hand of user holding the handle part and guide the foam or the water to drop toward the ground. Therefore, the problems that the user wearing the long-sleeve shirt has to roll up the sleeve before brushing his/her teeth, and the user has to always pay attention to the flowing direction of the foams to avoid the foam or the water wetting the forearm of the user are solved.

Moreover, when the location of the liquid-resisting tray on the brush body satisfies the condition L1=(L2−D1)×K+(D1+D2), the liquid-resisting tray keeps a distance from the lips of user to avoid uncomfortable feeling generated by the contact of the lips and the liquid-resisting tray, and the user can comfortably and steadily hold the handle part.

In addition, the liquid-resisting tray further includes the curved section. The distance between the fixing section and the first liquid-resisting section is adjustable by the curved section so that the liquid-resisting tray is able to fit connecting parts of brush bodies with different outer diameters.

In addition, the liquid-resisting tray further includes the reinforcing rib. The connecting portion between the first liquid-resisting section and the reinforcing rib has higher coefficient of elasticity so that the elastic force generated by the deformation of the fixing section is difficult to deform the first liquid-resisting section. As a result, the liquid-guiding groove located on the surface of the first liquid-resisting section still guide the liquid to flow to a desired direction when the fixing section is deformed.

What is claimed is:

1. A brush, comprising:
a brush body comprising a brush head part, a connecting part and a handle part, the connecting part having a first end and a second end which are opposite to each other, the first end connected to the brush head part, the second end connected to the handle part; and
a liquid-resisting tray installed on the connecting part;
wherein, a length of the brush head part is a, a length of the handle part is b, a length parameter associated with the length of brush head part and the length of handle part is K, a distance between the liquid-resisting tray and the first end of the connecting part is a tolerance parameter D1, a distance between the liquid-resisting tray and the second end of the connecting part is a tolerance parameter D2, a total length of the brush body is a first length L1, a length between a side of the brush head part away from the connecting part and the liquid-resisting tray is a second length L2, and the following conditions are satisfied:
K=(a+b)/a;
2.363≦K≦2.889; and
L1=(L2−D1)×K+(D1+D2).

2. The brush of claim 1, wherein the liquid-resisting tray comprises a fixing section, a first liquid-resisting section and a second liquid-resisting section, the fixing section is installed on the connecting part, the first liquid-resisting section is connected to the fixing section and surrounding the connecting part, the second liquid-resisting section is connected to and surrounding the first liquid-resisting section, and the second liquid-resisting section is inclined to the first liquid-resisting section.

3. The brush of claim 2, wherein the first liquid-resisting section has a front side, a rear side and a liquid-guiding groove, the front side and the rear side are opposite to each other, the front side is closer to the brush head part than the rear side, and the liquid-guiding groove is located at the front side.

4. The brush of claim 2, wherein the rear side of the first liquid-resisting section and the second liquid-resisting section forms a liquid-resisting groove.

5. The brush of claim 2, wherein the connecting part of the brush body has a fixing portion, the fixing portion matches with the fixing section of the liquid-resisting tray.

6. The brush of claim 1, wherein the connecting part further has a stopper located at a surface of the connecting part, and a distance between the stopper and the brush head part is larger than a distance between the liquid-resisting tray and the brush head part.

7. The brush of claim 6, wherein the stopper protrudes out from the surface of the connecting part, and a distance between an edge of the stopper and a central axis of the brush body is smaller than a distance between an edge of the second liquid-resisting section of the liquid-resisting tray and the central axis of the brush body.

8. The brush of claim 7, wherein the handle part has an anti-slip portion, the anti-slip portion is positioned around an end of the handle part close to the brush head part, and a distance between an edge of the anti-slip portion and the central axis of the brush body is smaller than the distance between the edge of the stopper and the central axis of the brush body.

9. The brush of claim 2, wherein the connecting section of the liquid-resisting tray further has a stopper located at a surface of the connecting section, and a distance between the stopper and the brush head part is larger than a distance between the first liquid-resisting section and the brush head part.

10. The brush of claim 9, wherein the stopper protrudes out from the surface of the connecting section of the liquid-resisting tray, and a distance between an edge of the stopper and a central axis of the brush body is smaller than the distance between an edge of the second liquid-resisting section of the liquid-resisting tray and the central axis of the brush body.

11. The brush of claim 10, wherein the connecting section of the liquid-resisting tray further has an anti-slip portion, the anti-slip portion is positioned around the surface of the connecting section, the stopper is located between the anti-slip portion and the first liquid-resisting section, and a distance between an edge of the anti-slip portion and the central axis of the brush body is smaller than the distance between the edge of the stopper and the central axis of the brush body.

12. The brush of claim 2, wherein the liquid-resisting tray is detachably installed on the connecting part of the brush body.

13. The brush of claim 12, wherein the liquid-resisting tray further comprises a curved section, the curved section connects the fixing section and the first liquid-resisting section, and the curved section is for adjusting a distance between the fixing section and the first liquid-resisting section.

14. The brush of claim 12, wherein the liquid-resisting tray further comprises a reinforcing rib, the first liquid-resisting section has a front side and a rear side which are opposite to each other, the front side is closer to the brush head part than the rear side, the reinforcing rib is connected to the rear side.

15. A brush, comprising:
a brush body comprising a brush head part, a connecting part and a handle part, the connecting part having a first end and a second end which are opposite to each other, the first end connected to the brush head part, the second end connected to the handle part; and
a liquid-resisting tray installed on the connecting part, the liquid-resisting tray comprising a fixing section, a first liquid-resisting section and a second liquid-resisting section, the fixing section installed on the connecting part, the first liquid-resisting section connected to the fixing section and surrounding the connecting part, the second liquid-resisting section connected to and surrounding the first liquid-resisting section, and the second liquid-resisting section inclined to the first liquid-resisting section.

16. The brush of claim 15, wherein the connecting part further has a stopper located at a surface of the connecting part, and a distance between the stopper and the brush head part is larger than a distance between the liquid-resisting tray and the brush head part.

17. The brush of claim 16, wherein the stopper protrudes out from the surface of the connecting part, and a distance between an edge of the stopper and a central axis of the brush body is smaller than the distance between an edge of the second liquid-resisting section of the liquid-resisting tray and the central axis of the brush body.

18. The brush of claim 17, wherein the handle part has an anti-slip portion, the anti-slip portion positions around an end of the handle part close to the brush head part, and a distance between an edge of the anti-slip portion and the central axis of the brush body is smaller than the distance between the edge of the stopper and the central axis of the brush body.
